(19) United States
(12) Patent Application Publication
(10) Pub. No.: US 2007/0186646 A1
(43) Pub. Date: Aug. 16, 2007

(54) Vibratory limit switch configuration and a process for correcting the switching point of a vibratory limit switch

(75) Inventors: Adrian Frick, Wolfach (DE); Martin Mellert, Steinach (DE)

Correspondence Address: NATH & ASSOCIATES, 112 South West Street, Alexandria, VA, 22314, US

(73) Assignee: VEGA Grieshaber KG, Wolfach (DE)

(21) Appl. No.: 11/639,330

(22) Filed: Dec. 15, 2006

Related U.S. Application Data
(60) Provisional application No. 60/773,342, filed on Feb. 15, 2006.

(30) Foreign Application Priority Data
Feb. 15, 2006 (DE) 10 2006 007 199.9

(51) Int. Cl. G01F 23/28

(52) U.S. Cl. 73/290 V

(57) ABSTRACT

The invention relates to a vibratory limit switch configuration and to a process for operating such a configuration, with a fork (2); a transmitting and/or receiving device (3) for generating a vibration (w(fr)) for the fork as dependent on an exciter signal, and for receiving a vibration from the fork and for generating a reception signal (e) as dependent on the received vibration; and a control device (4) for providing the exciter signal and/or for processing the reception signal, where a device (8, 8*) is provided for detecting the temperature (T) of the fork or the temperature (T) of a space adjacent to the fork.

The invention relates to an arrangement for a vibratory limit switch, with the features indicated in the preamble of patent claim 1, and to a process for correcting the switching point of a vibratory limit switch, with the features of patent claim 6.

In determining the limit state of a filling medium in a container, particularly a liquid medium, the prior art is acquainted with vibratory limit switch configurations in which a vibrating unit, for example a vibrating fork, protrudes a certain distance into the container and the vibrating unit is part of a mechanical-electrical vibrating system. Positioned at the back end of the vibrating fork is a vibratory transmitting and/or receiving device for generating a vibration as dependent on an exciter signal, which vibration sets the tuning fork into mechanical vibration. Vibrations induced by the excitation transducer are detected by a receiving transducer in order to issue suitable signalings and/or control signals to other devices and components, as performed by an evaluating unit.

In this kind of arrangement a vibrating fork is customarily inserted vertically from the upper end of the container, or laterally and horizontally into the interior of the container through the container wall. The transmitting and receiving device for the vibrations is usually represented by piezoelectrical drive units, which are stimulated by the exciter signal and are set into vibration. The vibrating frequency here is usually the resonant frequency of the tuning fork. A corresponding receiving circuit allows this frequency to be measured. By immersing the fork in a liquid, i.e., in the filling medium, the fork is damped and the frequency drops. A change of this kind is recorded by the evaluating unit of an installed electronic component and results in a switching command. Ideally the electronic unit has already been adjusted so that it performs a switching operation precisely in the center of the paddle, i.e., the fork configuration, for that case in which the fork is vertically installed and is immersed in water with a density of ρ=1.0. Since the drop in frequency is dependent on the density of the filling medium, the switching point is displaced for media with a density that is not equal to 1. To take this into account, the capability of moving the switching point back toward the paddle center in accordance with the density of the filling medium is often provided, specifically with the aid of a potentiometer or switch.

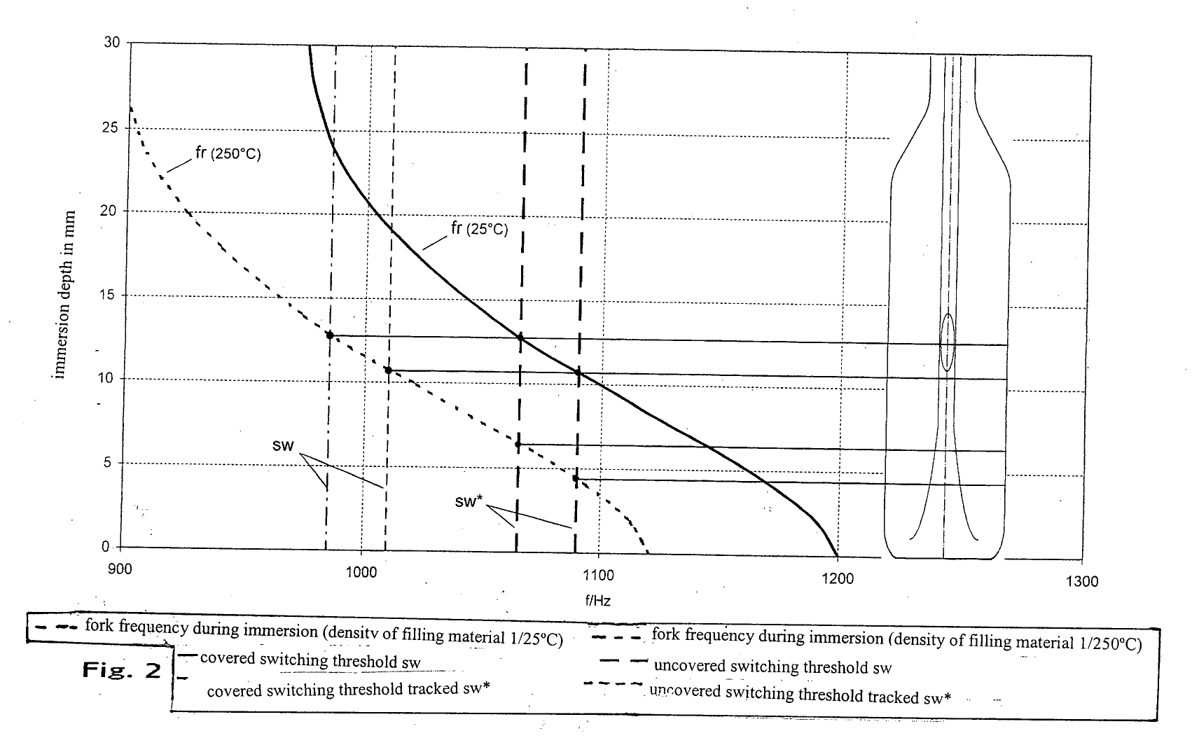

The goal of the invention is to enlarge the area of application for sensors and vibratory limit switches of this kind and to propose a control process which makes this possible. It is assumed that there is a desire for applications that operate at temperatures higher than currently possible. The maximum permissible temperatures for these sensors or vibratory limit switch configurations are steadily being increased, with the result that a temperature drift in the resonant frequency gains in importance. The resonant frequency of the vibrating fork drops with an increasing temperature inside the container; when the switching point frequency remains the same, the result is that the switching point shifts in the direction of the filling material, or toward the point of the fork for that case in which sensor is installed vertically. This is evident in FIG. 2.

The goal of the invention, therefore, is to specify a vibratory limit switch configuration or vibratory fill-level measuring configuration, as well as a process, which make it possible to compensate a switching point drift inside the container, as based on increasing temperature.

This problem is solved by a vibratory limit switch configuration, or vibratory fill-level measuring configuration, with the features of patent claim 1 and by a process for correcting the switching point of a vibratory limit switch in accordance with the features of patent claim 9. Advantageous embodiments are the subject matter of dependent claims.

Particularly preferred is a vibratory limit switch configuration or vibratory fill-level measuring configuration with a vibrating unit for generating a vibration, specifically in the form of a fork; a transmitting and/or receiving device for generating a vibration for the vibrating unit as dependent on an exciter signal or for receiving a vibration from the vibrating unit and generating a reception signal as dependent on the received vibration; a control device for providing the exciter signal and/or for processing the reception signal; and an evaluation device for processing the vibrating frequency, such that a device is provided for detecting the temperature of the vibrating unit or of a space adjacent to the vibrating unit. The control device for producing the exciter signal and/or for processing the reception signal and the evaluating device for processing the vibrating frequency may be optionally formed by a single component, e.g., by means of an integrated circuit.

Particularly preferred is a configuration in which the space adjacent to the vibrating unit is the interior of a container with a filling medium, whose limit state or fill level is detected by the configuration. The configuration is advantageous particularly for a limit-state measurement; however, a fill-level measurement with a temperature-compensated fork, e.g., in the mm range, can also be realized with an appropriately designed and controlled arrangement.

Particularly preferred is a configuration in which the temperature identifying device is a temperature sensor positioned in the container's interior.

Particularly preferred is a configuration in which the temperature identifying device is a temperature sensor which is connected to the vibrating unit or is installed between the vibrating unit and the vibratory transmitter and/or receiver.

Particularly preferred is a configuration with a correcting device for correcting a temperature-dependent change in a switching point or a switching point frequency, such that the correcting device specifically takes the form of the evaluating device.

Particularly preferred is a configuration with a storage device for storing fork parameters associated with the vibrating unit in the form of a fork, inclusive of an elasticity module for the fork material, as used in executing the temperature-dependent change in a switching point frequency.

Particularly preferred is a configuration in which the correcting device is designed to incorporate a change in the density of the filling material as a function of the temperature.

Particularly preferred is a process for correcting the switching point of a vibratory limit switch, in which process a control device generates an exciter signal for exciting a vibratory transmitter, such that the transmitter's vibration is transmitted to a vibrating unit, particularly a fork, or to a vibrating unit in the interior of a container, and such that a correction in the switching point is performed as a function specifically of the filling material in the container, and where the temperature of the vibrating unit or of the space adjacent to the vibrating unit is identified and is used by the evaluating device for correcting the switching point frequency as a function of temperature.

Particularly preferred is a process in which a switching point which has shifted with a rising temperature toward the filling material—i.e., in the direction of the fork tip, in the case of a vertically installed sensor—is corrected by the temperature-dependent compensation of the switching point frequency.

Particularly preferred is a process in which the uncovered frequency is identified as the frequency of the uncovered vibrating unit in the air and a covered frequency is calculated as dependent on the adjusted density of the filling material. The switching point frequency is then formed out of the arithmetic mean of these frequencies. For a vertically installed sensor the sensor then performs a switching operation in the center of the paddle of the vibrating unit.

Particularly preferred is a process in which the evaluation of the reception signal takes into account the temperature dependency of the elasticity module for the vibrating unit.

Particularly preferred is a process in which parameters are stored in a memory in the process of calibrating the vibratory limit switch configuration and/or before the startup by the customer, such that said parameters influence a switching point frequency as dependent on the temperature.

Particularly preferred is a process in which a change in the density of the filling material as caused by temperature is incorporated into the calculation of the switching point frequency, specifically for that case in which the filling material remains unchanged.

In order to track the switching thresholds as a function of temperature an appropriate sensor is provided; this sensor is placed in the vicinity of the fork, with as little a temperature gradient as possible. Ideally this temperature sensor will be a part of the electronic evaluating system, so that the frequency of the fork when surrounded by air can be calculated for every temperature, as dependent on the elasticity module for the material of the vibrating fork. In this way it is possible to counteract a temperature-dependent shift in the switching point.

Ideally the characteristic temperature curve of the elasticity module for the fork will be stored during calibration in a non-volatile memory.

For that case in which the filling material remains the same there is also the possibility of incorporating into the calculation a density change in the filling material as caused by a detected temperature. Either during calibration of the sensor or before startup by the customer the corresponding parameters can be transmitted to a memory assigned to the appropriate evaluating device.

An exemplary embodiment will next be described in greater detail on the basis of the drawing. Shown are:

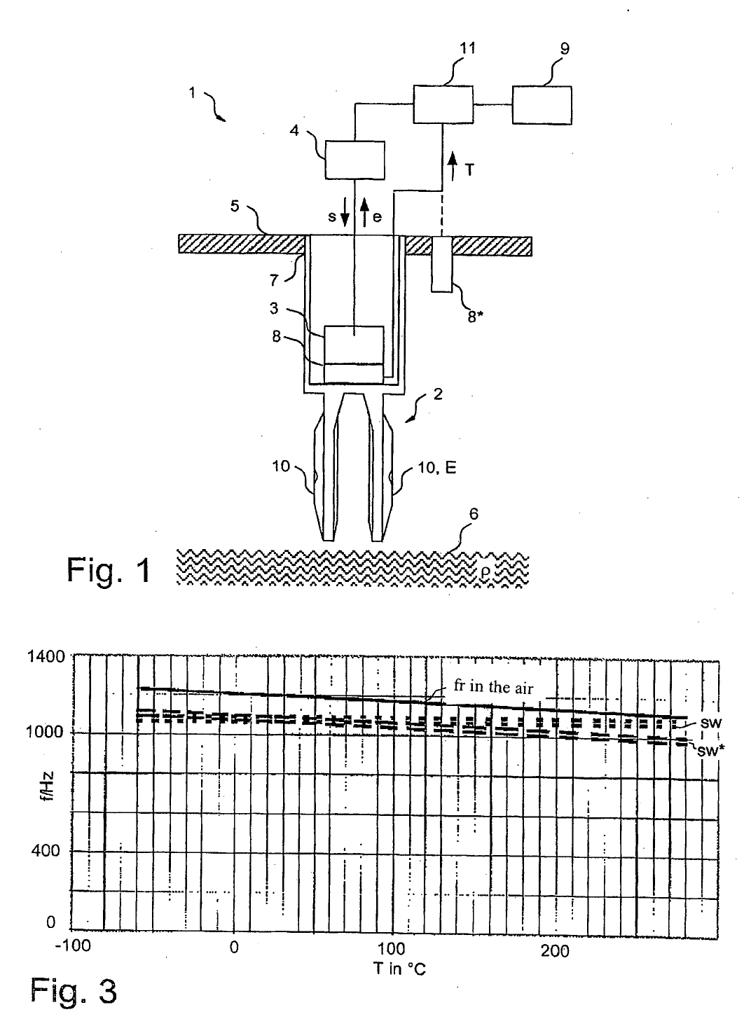

FIG. 1 a partial section of a container, with individual components belonging to a vibratory limit switch configuration, to graphically depict the basic principle of operation

FIG. 2 a diagram depicting the influence of immersion depth on the vibrating frequency of a fork

FIG. 3 a fork frequency in air and switching thresholds with and without tracking.

FIG. 1 shows a vibratory limit switch configuration 1 with a schematically depicted fork 2 serving as the vibrating unit. The fork will ideally exhibit two paddles 10. A transmitter, ideally in the form of one or several piezoelectrical elements and belonging to a vibratory transmitting and/or receiving device 3, generates an exciter vibration as dependent on an exciter signal s, and this exciter vibration is coupled into the fork 2. The mechanical vibration thus produced is converted into a reception signal e by the vibratory transmitting and/or receiving device 3. The exciter signal s is provided by means of a control device 4, which can exist as a component of the vibratory limit switch. The resonant frequency fr of the fork 2 is dependent on the temperature T of the fork 2, i.e., on the temperature T in the spatial area into which the fork is inserted. An evaluating device 11 or a combined control and evaluating device will ideally serve to process and/or evaluate the reception signal e, in order to provided corresponding display and/or switching signals. In the depicted exemplary embodiment the fork 2 is positioned in a container 5, which serves to receive the filling medium 6. In the depicted embodiment the back end of the fork 2 is guided through a container hole 7 in the upper wall of the container 5. The vibratory limit switch configuration 1 serves to determine the limit state of the filling medium 6 inside the container 5. When the height h of the filling medium 6 reaches the fork 2 an appropriate switching signal is emitted. The filling medium has a density ρ which influences the frequency fr of the vibrating fork 2 when the fork comes into contact with said filling medium 6.

Since the temperature T in the interior of the container 5 has a direct influence on the vibratory properties of the fork and on the resonant frequency fr, at least one temperature identifying device is provided, which determines the temperature T of the fork itself or the temperature T in the immediate vicinity of the fork 2. The specific temperature T is then fed to the evaluating device 11, which performs an appropriate correction or adjustment in the switching point frequency for cases in which there would otherwise be a switching point drift requiring correction.

Different types of temperature sensors may be employed as temperature identifying devices. Shown as an initial example is a temperature sensor 8 coupled directly to the fork 2. In the depicted example this temperature sensor 8 is positioned between the fork 2 and the vibratory receiving and/or transmitting device 3. In principle, a temperature sensor 8* can also be positioned inside the container as a component separate from the fork 2; in the present example, this is done to advantage in the vicinity of the fork 2. In this way the switching thresholds can be tracked as a function of the temperature T, as FIG. 3 shows in graphic form. Shown is the fork frequency fr in the air; also shown are two switching thresholds sw without tracking, which thresholds approach the frequency curve as the temperature T increases; and two switching thresholds sw* which are corrected by a suitable tracking of, or correction in, the switching point frequency and which consequently remain at a desired distance from the frequency fr.

If a temperature sensor is a part of the electronic evaluating system, the frequency fr of the fork 2 in the air can be calculated as dependent on the elasticity module E of the fork 2. As a function of the adjusted density ρ of the filling medium 6 it is possible to determine a so-called covered frequency as the frequency of a fork covered by the filling medium and to thereby position the switching point frequency precisely on the arithmetic mean of the covered frequency and an uncovered frequency. This is performed by the evaluating device 11. In addition, when the filling medium remains the same, the evaluating device 11 can be used to incorporate into the calculation a change in the density of said filling medium as caused by the temperature T.

Ideally the vibratory limit switch configuration will include a storage device 9, which provides parameters for the evaluating device 9. In particular, the storage device 9 serves to store parameters such as the elasticity module E of the fork 2 and characteristic values for the fork's dependency on the temperature. Appropriate compensating curves and compensating characteristics can also be deposited in the storage device 9.

### LIST OF REFERENCE NUMERALS

1 vibratory limit switch configuration
2 fork/vibrating unit
3 vibratory transmitter and/or receiver
4 control device
5 container
6 filling medium
7 container hole
8, 8* temperature sensors
9 storage device
10 paddle
11 evaluating device
sw switching thresholds without tracking
sw* switching thresholds with tracking
E elasticity module E of the fork
T temperature T of the fork
fr fork frequency
ρ density of the filling medium

1. A vibratory limit switch configuration (1) or vibratory fill-level measuring configuration with
a vibrating unit (2),
a transmitting and/or receiving device (3) for generating a vibration for the vibrating unit as dependent on an exciter signal and for receiving a vibration from the vibrating unit and generating a reception signal as dependent on the received vibration,
a control device (4) for providing the exciter signal and/or for processing the reception signal (e), and
an evaluation device for processing the vibrating frequency,
wherein
a temperature detector (8, 8*) is provided for detecting the temperature (T) of the vibrating unit, or of a space adjacent to the vibrating unit.

2. A configuration in accordance with claim 1,
wherein
the vibrating unit is a fork (2).

3. A configuration according to claim 1, wherein the space adjacent to the vibrating unit is the interior of a container with a filling medium (6), whose limit or fill level is detected by the configuration.

4. A configuration according to claim 2,
wherein
the temperature detector is a temperature sensor in the interior of the container.

5. A configuration according to claim 1,
wherein
the temperature detector (8) is a temperature sensor which is connected to the vibrating unit or is installed between the vibrating unit and the vibratory transmitter and/or receiver.

6. A configuration according to claim 1,
wherein
a correcting device is provided for correcting a temperature-dependent change in a switching point, such that the correcting device takes the form of the evaluating device.

7. A configuration with a storage device (9) for storing fork parameters associated with the vibrating unit in the form of a fork, inclusive of an elasticity module (E) for the fork material used for executing of the temperature-dependent change in a switching point frequency.

8. A configuration according to claim 5,
wherein
the correcting device is designed to incorporate a density change in the filling material (6) as dependent on the temperature (T).

9. A process for correcting the switching point of a vibratory limit switch, in which
a control device (4) generates an exciter signal for exciting a vibratory transmitter, such that
the vibration of the transmitter is transmitted to a vibrating unit (2) in the interior of a container (5), and
a correction in the switching point is performed,
wherein
the temperature (T) of the vibrating unit, or of the space adjacent to the vibrating unit, is determined and is used by the evaluating device (4) for correcting the switching point frequency.

10. A process according to claim 9,
wherein
the vibrating unit is a fork (2).

11. A process according to claim 9,
wherein
a switching point displaced toward the filling material with a rising temperature is corrected by the temperature-dependent compensation of the switching point frequency.

12. A process according to claim 9,
wherein
an uncovered frequency of the uncovered vibrating unit in the air is identified, and a covered frequency and the switching point frequency are calculated as a dependent on the adjusted density (ρ) of the filling material.

13. A process according to claim 9,
wherein
the temperature-dependent elasticity module (E) of the vibrating unit is taken into account in evaluating the reception signal.

14. A process according to claim 9,
wherein
parameters are stored in a memory (9) in the process of calibrating the vibratory limit switch configuration and/or before customer startup, such that said parameters influence the switching point frequency as dependent on the temperature (T).

15. A process according to claim 9,
wherein
a change in the density (ρ) of the filling material (6) caused by temperature (T) is incorporated into the calculation of the switching point frequency, specifically for that case in which the filling material in the container (5) remains unchanged.
